(19) United States
(12) Patent Application Publication
(10) Pub. No.: US 2011/0092101 A1
(43) Pub. Date: Apr. 21, 2011

(54) METHOD FOR JOINING PLASTIC PARTS OF ELECTRIC OR ELECTRONIC COMPONENTS

(75) Inventors: Stefan Sick, Baden-Baden (DE); Tobias Kochjohann, Bad Lippspringe (DE); Christian Helmig, Detmold (DE)

(73) Assignee: Phoenix Contact GmbH & Co. KG

(21) Appl. No.: 12/377,547

(22) PCT Filed: Aug. 15, 2007
(86) PCT No.: PCT/EP2007/007195

§ 371 Date: Dec. 17, 2010

(30) Foreign Application Priority Data
Aug. 15, 2006 (DE) 102006038330.3

(51) Int. Cl. H01R 13/40; B32B 37/12

(52) U.S. Cl. 439/625; 156/334; 156/327

(57) ABSTRACT

Disclosed is a method for joining two or several plastic parts of an electrical or electronic component, preferably a particularly multipole connector. According to said method, the plastic parts that are to be joined are joined together in a gluing process by means of an adhesive. The adhesive is selected so as to be compatible with the synthetic material of which the plastic parts that are to be joined are made, thus ensuring high-quality adhesion while reducing the number of materials used for making electrical and electronic parts and simplifying dismounting and recycling.

The invention concerns a method for assembling electronic and electrical devices, especially modules, preferably multipole pin-and-socket connectors, which can differ in color, shape and function. This invention also encompasses the products that are made with the help of this method. With the method in accordance with the invention, modular components with polymer housings can be joined by means of a new adhesive or polymer welding method that has as a result, in particular, a permanent and heat-, cold- and moisture-resistant bond or adhesion of the components. In particular, the invention concerns a method for joining two or more plastic parts of electrical or electronic components, preferably and in particular multipole pin-and-plug connectors, and the products joined or assembled in this way, and their use.

The plastic or polymer housings of currently available electrical devices and components consist of polymers, for example, polyamides like polyamide 6 (PA 6) or polyamide 6.6 (PA 6.6), or polyterephthalates like polybutadiene terephthalate (PBT).

In general housings, particularly plastic housings, in particular multipole pin-and-socket connectors, are produced in an injection molding process. For special-purpose designs and mass production of devices in a large number of function and color variations with identical connection points, modules with different colors and functions are made in advance. The individual modules are assembled in processes having process times that are as short as possible.

The currently used click-lock systems for connecting plastic parts have certain limitations with regard to the strength of the connection between the plastic parts. To join the plastic parts, suitable adhesives, for example, acrylic adhesives or polyurethane-based adhesives, have in many cases sufficient adhesion properties, but they harden too slowly for production speed and production throughput; since the adhesives and the polymer material of the housings have different thermal expansion behaviors, separation of the adhesive can also occur when the devices are exposed to climatic variation.

Other methods for joining plastic parts are also known to one skilled in the art: for example, he is aware of methods like cold welding with solvents or injection welding with molten polymers. However, analyses of fractures produced under stress frequently show cracks in the bonding layer, which lead to failure of the connection between the assembled plastic parts.

Another problem in assembling prefabricated plastic parts is maintaining the requirements for the dimensions of the end products in accordance with various norms and standards.

In order to be able to limit the variability of components with regard to functions and colors, it would therefore be desirable to achieve the necessary differences in the measurements by varying the thickness of the bonding layer between the plastic parts. However, cold welding processes with solvents lead only to swelling of the contact surfaces of the individual plastic parts, but do not allow filling of specific intermediate spaces. Traditional adhesion processes on the other hand, have cohesion problems in the case of thick adhesive layers. The currently used adhesives are characterized by high adhesion forces and are used with the goal of producing a strong bond as a thin layer between two surfaces; if the adhesive layers are thicker, cracks can occur in the adhesive layer because of the low forces of cohesion within the adhesive material, especially if there are climatic and/or mechanical stresses.

Besides the methods described above, various thermoplastic welding processes have also been developed in the prior art, for example, high-frequency welding, vibrational welding, laser transmission welding and spin welding. These methods are indeed suitable for a wide range of welding conditions and process parameters; however, in all of these methods there is a release of energy in the region of the contact surfaces. The melting of the relevant plastic material can be controlled in principle, but nevertheless there are two crucial disadvantages. For one, the energy release can affect the ratio between crystalline and amorphous thermoplastic material such that, when the relevant product is used, internal stresses can occur in the material if it is under thermal and/or mechanical loads. For another, additives may be required to promote the flow of the melting material at the contact surfaces, which, however, can produce undesirable secondary effects, for example a change of the slip property or insulation property of the material.

WO 95/26868 A1 describes the use of a specific mixture of highly crystalline polyamide and semiaromatic amorphous polyamide to improve the results in vibration, ultrasound, infrared and heating element welding. US 2002/143117 A1 describes an optimum ratio between aromatic and aliphatic polyamides for achieving the best results in welding. EP 0 070 001 A1 describes the use of selected thermoplastic polyamide copolymers together with semicrystalline polyamides to produce casting resins. These publications utilize the advantages of mixtures of amorphous and crystalline thermoplastic plastics; however, the relevant materials consist of at least two different polymers, so that there is increased expense in recycling them.

EP 1 254 919 A1 describes the advantages of using polyamides having different softening points and the simultaneous use of additives that increase the shear viscosity of the melts during welding. U.S. Pat. No. 4,919,987 A describes an optimum surface shape for vibration welding and optimum surface structures of contact surfaces.

All of these publications call for a release of energy, which has a negative effect for the thermal history of the end products and the ratio of amorphous to crystalline material.

Cold welding processes are used in the plastics processing industry, for example, in assembling PVC tubular material or to produce seams between nonwoven PVC floor coverings. However, such methods are not suitable for plastic materials such as are used in the field of electrical and electronic components. In particular, these methods are not suitable for thermoplastic plastic materials like polyamides or polyterephthalates, or for the assembly of cast plastic parts, especially injection-molded plastic parts. In particular, it must be noted that polyamides are known for reacting sensitively and critically to the effects of heat, and the thermal history can have a considerable effect on the material properties of the end product.

The invention therefore is based on the task of making available an efficient method for joining plastic parts of electrical or electronic components, especially multipole pin-and-socket connectors, which method at least largely avoids the disadvantages of the methods of the prior art that were mentioned above, or at least reduces them.

The applicant now has surprisingly discovered that plastic parts of electrical or electronic components, particularly and especially multipole pin-and-socket connectors, can be joined together in an efficient way by joining the plastic parts that are to be joined using an adhesive in a bonding process selected such that the adhesive is compatible with the plastic that comprises the plastic parts to be bonded. Other especially advantageous embodiments of this invention are the object of the dependent claims.

Other objects of the invention are the products obtained with the method in accordance with the invention, which have plastic parts joined in the manner in accordance with the invention, in particular modular components (for example, housing parts).

In particular, within the scope of the invention an adhesive is used that is based on a polymer that is the same or similar to the plastic parts to be joined, in particular, containing or consisting of said polymer.

In a particular embodiment of the invention, the plastic parts to be joined themselves (for example, modular or compatible parts of a housing) consist of polymers that are the same or similar or that are at least compatible with each other, and the adhesive is chosen such that it is based on polymers that are the same as or similar to the polymers of the plastic parts that are to be joined.

The method in accordance with the invention leads to a number of advantages, which are to be illustrated below in some examples.

Because the adhesive chosen in accordance with the invention is selected so that it is compatible with the plastic or the polymers of the plastic parts that are to be joined, in particular it is based on a polymer that is the same or similar to the plastic parts to be joined, a tension-free bond is achieved, i.e., the internal tension between the contact surfaces of the joined plastic parts and the adhesive layer is reduced to a minimum or is absent.

Because polymer materials that are similar or identical are used to make the adhesive, on the one hand, and the plastic parts to be joined on the other, one obtains similar polymer structures that have identical or similar behaviors with regard to their physicochemical and mechanical properties. Under climatic and/or mechanical stresses, the identical or similar polymer materials react in the same way, so that tensions are avoided even under extreme conditions.

Moreover, the use of similar polymer materials for the adhesive that is selected in accordance with the invention, on the one hand, and the plastic parts of the electrical or electronic component that are to be joined on the other, leads to a clear simplification and a reduction of material used for making these components. Thus, disassembly and recycling are considerably simplified. Also, the durability and stability of the bond, even under extreme loads (for example, thermal, climatic and/or mechanical loads) are considerably improved by this.

Because of the similar polymer materials for the adhesive used, on the one hand, and the plastic parts that are to be joined on the other, a substantially homogeneous stable joint or a homogeneous bond is obtained after the bonding and hardening of the adhesive. Because of the stability of this bond it is equally possible to vary the amount or thickness of the adhesive application in wide ranges without the quality of the adhesive connection suffering; in this way the thickness of the adhesive layer between the contact surfaces of the plastic parts to be joined can be varied in wide ranges, which can be utilized to vary or control the measurements of the electrical or electronic components in a targeted way, in particular with regard to maintaining specific dimensions, for example, for different uses, norms, standards or the like.

The method in accordance with the invention enables, in particular, the assembly or joining of electrical connections of modules with polymer housings that consist in particular of thermoplastic plastics, for example, polyamides or polyesters, especially polyterephthalate (for example, polyethylene terephthalate, PET, polybutylene terephthalate PBT or their copolymers or mixtures, etc.). The adhesive used in accordance with the invention is advantageously selected from the same base polymer as the plastic parts to be joined, thus enabling simple recycling of the material. In particular, the adhesive material that is used is capable of filling specific intermediate spaces between the plastic parts that are to be joined, in order to satisfy requirements for the finished measurements of products, which are set, for example, by customers or regionally specific conditions (for example, norms, standards, etc.). As a consequence of the tailored choice of adhesive material, a permanent adhesion and cohesion in the region of the adhesive joint is ensured.

The invention is described below by means of particular embodiments, which, however, are not limiting in any way with respect to the object of the application, but rather serve only to illustrate the general notions of the invention:

Within the scope of the invention, plastic housings of components for electronic or electrical devices, for example, those made by injection molding processes, can be bonded by casting thermoplastic materials in open molds or by a traditional method for shaping polymer housings.

The polymer material of the multipart plastic housings can be a thermoplastic material that consists chiefly of, for example, polyamides like PA-4 (polymer based on aminobutanoic acid), PA-6 (polymer based on c-caprolactam), PA-7 (polymer based on amino-7-heptanoic acid), PA-8 (polymer based on capryl lactam), PA-9 (polymer based on amino-9-nonanoic acid), PA-10 (polymer based on amino-10-decanoic acid), PA-11 (polymer based on amino-11-undecanoic acid), PA-12 (polymer based on lauryl lactam), PA-4.6 (polymer based on tetramethylenediamine and adipic acid), PA-6.6 (polymer based on hexamethylenediamine and adipic acid), PA-6.9 (polymer based on hexamethylenediamine and acetic acid), PA-6.10 (polymer based on hexamethylenediamine and sebacic acid), PA-6.12 (polymer based on hexamethylenediamine and dodecanoic acid) or of copolymers like PA-6.6/6 (copolymer based on hexamethylenediamine, adipic acid and sebacic acid) and their derivatives.

A second group of materials for the plastic housings of electrical or electronic components can be polyesters, for example, ones based on dicarboxylic acids like terephthalic acid (1,4-benzenedicarboxylic acid), the polymers or polyesters thereof (i.e., polyterephthalates), for example, polyethylene terephthalate (PET), polybutylene terephthalate (PBT) and their copolymers or mixtures.

According to one embodiment of the invention, the selected adhesive for polyamide housing components to be joined can be a polyamide having morphological properties very similar to the morphological properties of the housing material to be joined. To produce the adhesive, this polymer can be dissolved either in high-polarity organic or inorganic acids or in suitable solvents, for example, resorcinol (ortho-dihydroxybenzene). In this case the concentrations of the polymer material for the adhesive exceed 2 wt % and can be as high as 80 wt %. The preferred concentrations in this case lie in the range of 18-35 wt %. The selected solvent should have a high volatility under working conditions, in particular a boiling point in the range of 0-100° C.

In a first preferred embodiment of the adhesion process in accordance with the invention, formic acid can be used as polar organic acid. The concentration of the selected polyamide can be in the range of 23-30 wt %. The adhesive can be produced in the first production step: thickeners such as xanthan or guar flour may optionally be necessary, particularly in concentrations between 0.01 and 0.2 wt %, in order to stabilize the adhesive solution over a longer period of time and to avoid the settling of the components. In addition, additives, preferably the same additives as those in the material of the polymer housing, can be added to the adhesive, for example, pigments, fillers or flame retardants. During the bonding or welding process the temperature should be between 15 and 30° C. The filling of a specific intermediate space between the plastic parts that are to be joined can be realized, for example, by spot application of the adhesive onto the surface of one of the two parts to be joined and then pressing the parts together under slight pressure, in particular in the range of 0.1-20 N/m². The dynamic viscosity of the adhesive at 25° C. should be selected to be in the range of 500-40,000 mPa·s, preferably 8000-25,000 mPa·s.

In a second preferred embodiment of the invention, the polyamide can be ground, preferably cold-ground, for example, at −196° C. (for example, in a liquid-nitrogen-cooled grinder). The average particle size of the polyamide after grinding can lie in the range of 0.1-50 μm. The polyamide powder can then be filled into a chamber with a cartridge of glass, PTFE, fluorinated olefin or ceramic, where the cartridge is fitted with a mixing device, for example, with a firmly installed agitator. A second chamber is filled with a solvent. At the beginning of the bonding operation the two chambers are connected to each other. Then the contents of the chambers are mixed thoroughly via the mixing device. The adhesive in this case develops in situ, i.e., in place and position, so that no stabilization is required.

In a third preferred embodiment, the prefabricated or in situ-produced adhesive is injected into the intermediate space between the contact surfaces of the plastic parts that are to be joined.

In a fourth preferred embodiment of this invention the contact surfaces of the plastic parts are preheated to maximum temperatures of about 80-110° C., thus significantly reducing the processing time for hardening the adhesive.

In another preferred embodiment, the housing material can consist of a polyester, for example, a polybutylene terephthalate (PBT). In this case a polymer material of the same chemical composition as the adhesive is dissolved in a highly polar organic solvent, for example, hexafluoropropanol, where the concentration of the adhesive polymer can vary in the range of 0.2-50 wt %, preferably 20-35 wt %, with respect to the total weight of the adhesive. The processing temperature can lie in the range of 0-110° C.

With all of the described embodiments, the adhesive layer can vary in the range of 0.0001-5 mm, preferably 0.05-0.3 mm, with respect to the hardened adhesive layer.

The plastic parts that are produced or assembled with the method in accordance with the invention prove to be extremely temperature-stable in a wide temperature range, for example, in a temperature range of −90-90° C. The assembled parts maintain their tensile strength and bending strength even after long heat aging periods, for example, 14 days of storage at 80° C. and simulations of climate changes in the range of −90-80° C. In rupture tests under mechanical load (200 Newtons), the only fractures found were in the housing of the material at extreme load, not in the adhesive areas.

Notably, measurements of the glass transition temperature by dynamic differential calorimetry give the same results for the contact surfaces of the bonded housing and for the adhesive layer. The relevant DSC curves are very similar, which supports the statement that the housing material and the hardened adhesive have similar crystallinities.

The method in accordance with the invention enables efficient bonding of plastic parts of electrical or electronic components with high production throughput and short processing times when assembling electric and electronic components. For this reason it is especially suitable for industrial use.

To ensure the effect of the highest possible adhesion of the adhesive layer, the concentrations of adhesive polymers in the adhesive solutions or dispersions that are used should not go significantly below or beyond the concentrations specified in the claims. Sufficient adhesion is not always achieved if one goes below the specified lowest concentration. Moreover, if the concentrations are too low there can be a transformation of crystalline phases to amorphous individual polymer chains because of the large amount of, in particular, polar solvent, which is equally undesirable. On the other hand, if the specified concentration is exceeded, it is assumed that in a bonding or joining operation there will be a reorganization of the remaining amorphous and crystalline phases in the solution in an interaction with the amorphous and crystalline polymer fibers at the contact surfaces of the polymer housing.

The method in accordance with the invention is especially suitable for bonding or joining modular individual parts, especially individual parts of plastic housings of electrical or electronic components, preferably and in particular multipole pin-and-socket connectors. Such connectors are described in the applicant publications DE 38 00 846 A1 and DE 10 2004 009 071 A1, the relevant disclosure content of which is hereby incorporated in its entirety by reference. Up to now the individual modules or housing parts of such connectors, especially plug strips and mating plug strips, were joined together by click-lock connecting systems. The method in accordance with the invention enables for the first time a reliable connection of these parts by means of an industrially feasible bonding process that can be carried out in particular with high production throughput and high reproducibility. Experiments conducted by the applicant on products joined in accordance with the invention with different plastic layer thicknesses and different application methods did not find any cracks, fractures or the like on the joined contact surfaces in the corresponding mechanical load tests, even after progressive thermal loading of the samples (72 h heat load at 70° C.). At most, fractures developed in the housing material itself, but not at the adhesive sites. The tests conducted by the applicant impressively confirm the performance of the method in accordance with the invention.

Another object of the invention is the electrical or electronic components consisting of individual plastic components obtained by the method in accordance with the invention, i.e., bonded, preferably pin-and-socket connectors or their modules (for example, plug strips and mating plug strips).

In particular, electrical or electronic components, preferably in the form of multipole pin-and-socket connectors, are an object of the invention, where the components in each case have two or more plastic parts, especially individual modules such as housing parts or the like, which are joined together, where the plastic parts are joined by means of an adhesive in a bonding process, the adhesive being chosen such that it is compatible with the plastic that comprises the plastic parts that are to be joined.

1. A method for joining two or more plastic parts of an electrical or electronic component, preferably and in particular a multipole pin-and-socket connector, characterized by the fact that the plastic parts to be joined are joined together by means of an adhesive in a bonding process, where the adhesive is selected such that it is compatible with the plastic that comprises the plastic parts to be joined.

2. A method as in claim 1, characterized by the fact that an adhesive that is based on polymers identical or similar to those of the plastic parts that are to be joined, particularly containing or consisting of these polymers, is used as adhesive.

3. A method as in claim 1 or 2, characterized by the fact that the plastic parts to be joined consist of identical or similar or at least compatible polymers and an adhesive that consists of polymers that are identical or similar to those of the plastic parts to be joined, in particular containing or consisting of these polymers, is used as the adhesive.

4. A method as in one of claims 1-3, characterized by the fact that the plastic parts to be joined consist of a thermoplastic polymer, especially polyamide(s) and/or polyester(s), especially polyterephthalate(s), and the adhesive that is used is selected from thermoplastic polymers corresponding to the plastic parts to be joined, in particular polyamide(s) and/or polyester(s), especially polyterephthalate(s).

5. A method as in one of claims 1-4, characterized by the fact that the plastic parts to be joined are made in a casting process, especially in an injection molding process, particularly from thermoplastic polymers, preferably polyamide(s) and/or polyester(s), especially polyterephthalate(s).

6. A method as in one of claims 1-5, characterized by the fact that a physically binding adhesive is used as adhesive.

7. A method as in one of claims 1-6, characterized by the fact that a solvent or dispersion adhesive is used as adhesive, where, in particular, the adhesive polymer is present in a preferably polar solvent or dispersion agent, in particular in quantitative concentrations of 0.2-80 wt %, especially 2-50 wt %, preferably 15-40 wt %, especially preferably 20-35 wt %.

8. A method as in claim 7, characterized by the fact that the solvent or dispersion agent is selected from inorganic or organic acids, preferably carboxylic acids, especially formic acid, organic, preferably aromatic, solvents like resorcinol (ortho-dihydroxybenzene), and alcohols like hexafluoropropanol, and their mixtures and/or that the solvent or dispersion agent is volatile, in particular that it has a boiling point of 0-110° C., and/or that the adhesive at 25° C. has a dynamic viscosity of 500-40,000 mPa·s, preferably 8000-25,000 mPa·s.

9. A method as in one of claims 1-8, characterized by the fact that the adhesive is produced in situ, in particular by preferably obligatory mixing-together of the adhesive components, in particular the adhesive polymer, on the one hand, and solvent or dispersion agent on the other hand, immediately before application of the adhesive, where, in particular, the adhesive polymer, optionally after preferably cold grinding to a desired particle size, preferably 0.1-50 μm, is brought into contact with the solvent or dispersion agent and mixed therewith.

10. A method as in one of claims 1-9, characterized by the fact that the method is carried out at temperatures, especially ambient and/or processing temperatures, in the range of 0-50° C., in particular 15-30° C.

11. A method as in one of claims 1-10, characterized by the fact that other ingredients are added to the adhesive, in particular additives and/or auxiliary substances, preferably selected from fillers, pigments, flame retardants, stabilizers, slip agents, plasticizers and their mixtures, where, in particular, the additional ingredients of the adhesive are selected to be compatible with the plastic parts to be joined, in particular additives and/or auxiliary substances are added that are the same as or similar to those of the plastic parts to be joined.

12. A method as in one of claims 1-11, characterized by the fact that the adhesive and/or the contact surfaces of the plastic parts that are to be joined, preferably only the contact surfaces of the plastic parts that are to be joined, are heated before and/or during the bonding operation, in particular to temperatures in the range of 50-150° C., preferably 80-110° C.

13. A method as in one of claims 1-12, characterized by the fact that, to join the plastic parts, the adhesive is first applied to the, contact surfaces of the plastic parts to be joined, in particular by means of spot application, injection, spraying, atomization or spreading with a knife, and the contact surfaces are then pressed together, in particular at a pressure of 0.1-20 N/cm².

14. A method as in one of claims 1-13, characterized by the fact that the adhesive is applied in an amount such that the thickness of the resulting adhesive layer is 0.0001-5 mm, especially 0.05 and 0.3 mm, and/or that the measurement, in particular the dimensional precision, of the joined product is controlled via the selected thickness of the adhesive layer, especially with regard to imposed requirements, norms, standards or the like.

15. A method as in one of claims 1-14, characterized by the fact that the hardened adhesive layer, on the one hand, and the joined plastic parts on the other, have the same and/or similar crystallinities and/or morphologies and/or glass transition temperatures.

16. A method as in one of claims 1-15, characterized by the fact that the plastic parts to be joined are modular individual parts or individual modules, particularly housing parts of an electrical or electronic component, preferably and in particular a multipole pin-and-plug connector.

17. An electrical or electronic component, preferably in the form of and in particular a multipole pin-and-plug connector, where the component has two or more plastic parts, particularly individual modules such as housing parts or the like, which are joined together, characterized by the fact that the plastic parts are joined to each other by means of an adhesive in a bonding process, where the adhesive is selected such that it is compatible with the plastic that comprises the plastic parts to be joined.

18. An electrical or electronic component, preferably in the form of, in particular, a multipole pin-and-plug connector, where the component has two or more plastic parts, particularly individual modules such as housing parts or the like, which are joined together, characterized by the fact that the joining of the plastic parts is produced by a bonding process as in one of claims 1-16.
